(19) United States
(12) Patent Application Publication
(10) Pub. No.: US 2007/0013313 A1
(43) Pub. Date: Jan. 18, 2007

(54) PLASMA DISPLAY APPARATUS AND DRIVING METHOD THEREOF

(75) Inventor: Kirack PARK, Gyeongsangbuk-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/427,433

(22) Filed: Jun. 29, 2006

(30) Foreign Application Priority Data
Jul. 18, 2005 (KR) 10-2005-0064981

(51) Int. Cl. H01J 17/02

(52) U.S. Cl. 313/610

(57) ABSTRACT

The present invention relates to a plasma display apparatus which may simplify its manufacturing process and optimize its brightness and luminous property. A plasma display apparatus according to an embodiment of the present invention comprisies a front substrate and a rear substrate; a plurality of barrier ribs forming a plurality of discharge cells, the barrier ribs formed between the front substrate and the rear substrate; and a black frame separating an effective screen and a non-effective screen of the front substrate, wherein the black frame covers portions of one and more of the outermost discharge cells in the effective screen. Therefore, the present invention may simplify the manufacturing process of the plasma display apparatus and improve the brightness and luminous property, thus enhancing image quality.

This Nonprovisional application claims priority under 35 U.S.C. §119(a) on Patent Application No. 10-2005-0064981 filed in Korea on Jul. 18, 2005 the entire contents of which are hereby incorporated by reference.

### BACKGROUND OF THE INVENTION

1. Field of the Invention

The present invention relates to a plasma display apparatus.

2. Description of the Background Art

A plasma display panel generally comprises a front panel and a rear panel. Barrier ribs formed between the front panel and the rear panel form discharge cells. Each of the discharge cells is filled with an inert gas containing a main discharge gas such as neon (Ne), helium (He) or a Ne—He gas mixture and a small amount of xenon (Xe). When a high frequency voltage generates a discharge of the inert gas, the discharge of the inert gas emits vacuum ultraviolet rays. A phosphor formed between the barrier ribs emits visible light by vacuum ultraviolet rays_to display an image on the plasma display panel. Since the plasma display panel can be manufactured to be thin and light, the plasma display panel has been considered as a next generation display apparatus.

FIG. 1 is a prospective view of illustrating a discharge cell structure of a conventional plasma display panel.

Referring to FIG. 1, a discharge cell of a three-electrode AC surface discharge type plasma display panel comprises a scan electrode Y and a sustain electrode Z formed on a front substrate 10, and an address electrode X formed on a rear substrate 18. Each of the scan electrode Y and sustain electrode Z has a line width which is narrower than that of transparent electrodes 12Y, 12Z and transparent electrode 12Y, 12Z, and comprises metal bus electrodes 13Y, 13Z formed on the verge of one side of the transparent electrodes. The transparent electrodes 12Y, 12Y are typically made of ITO and formed on the front substrate 10. The metal bus electrode 13Y, 13Z are generally made of a metal such as Cr and formed on the transparent electrodes 12Y, 12Z, which serve to reduce voltage drop by the transparent electrodes 12Y, 12Z with high resistance.

An upper dielectric layer 14 and a protection film 16 are deposited on the front substrate 10 on which the scan electrode Y and sustain electrode Z are formed in parallel with each other. Wall charges created during plasma discharge are accumulated on the upper dielectric layer 14. The protection film 16 prevents damage to the upper dielectric layer 14 due to sputtering caused by plasma discharge and increases the emission efficiency of the secondary electrons. The protection film 16 is typically made of MgO.

A lower dielectric layer 22 and barrier rib 24 are formed on the rear substrate 18 on which the address electrode X is formed, and a phosphor layer 26 is applied on the surface of the lower dielectric layer 22 and the barrier rib 24. The address electrode X is formed in the direction of intersecting the scan electrode Y and sustain electrode Z. The barrier rib 24 is formed in the form of a stripe or lattice so as to prevent ultraviolet and visible light generated by discharge from leaking to neighboring discharge cells. The phosphor layer 26 is excited by ultraviolet rays generated by the plasma discharge, thus emitting any one of Red, Green, and Blue visible lights. An inert mixture gas is injected in a discharge space between the front/rear substrates 10, 18 and barrier rib 24.

As such, the plasma display apparatus comprises the aforementioned plasma display panel which comprises a driver for driving the plasma display panel, a film type filter formed on its front substrate for providing a predetermined function, an image processing unit for displaying images, and the like.

Here, on the verge of the plasma display panel may be formed a black frame for covering non-effective screens.

The black frame covers the verge of the panel, i.e. a portion which does not display images, and defines the effective display screens.

However, there may be difficulty on the manufacturing process in the course of forming the black frame. For example, the outside border line of the discharge cells corresponding to the verge of the panel may fail to form a straight line by the shape or arrange structure of the discharge cells. At this time, in a case where the black frame is formed within the boundary line, a problem may occur which causes the difficulty in performing alignment.

In addition, a problem may occur which reduces the accuracy of defining the effective display screen and deteriorates image property.

### SUMMARY OF THE INVENTION

Accordingly, an object of the present invention is to solve at least the problems and disadvantages of the background art.

One aspect of the present invention is to provide a plasma display apparatus which may solve the difficulty in performing alignment during the manufacturing process.

Another aspect of the present invention is to provide a plasma display apparatus which may improve its brightness by adjusting its effective screen to be an optimized state.

Still another aspect of the present invention is to provide a plasma display apparatus which may improve its luminous property.

A plasma display apparatus according to an embodiment of the present invention comprises a front substrate and a rear substrate; a plurality of barrier ribs forming a plurality of discharge cells, the barrier ribs formed between the front substrate and the rear substrate; and a black frame separating an effective screen and a non-effective screen of the front substrate, wherein the black frame covers portions of one and more of the outermost discharge cells in the effective screen.

The present invention may perform the easy alignment during the manufacturing process.

In addition, the present invention may improve the brightness by maximizing the effective screen.

In addition, the present invention may improve the luminous property.

### BRIEF DESCRIPTION OF THE DRAWINGS

The embodiment of the invention will be described in detail with reference to the following drawings in which like numerals refer to like elements.

FIG. 1 is a prospective view of illustrating a discharge cell structure of a conventional three-electrode AC surface discharge type plasma display panel.

FIG. 2 is a view of illustrating an example of a black frame formed on a plasma display panel of the present invention.

FIG. 3 is a view of showing an example of a delta type discharge cell structure for illustrating an example of a plasma display apparatus of the present invention.

FIG. 4 is a view of illustrating a first embodiment of forming a black frame of a plasma display apparatus of the present invention.

FIG. 5 is a view of illustrating a second embodiment of forming a black frame of a plasma display apparatus of the present invention.

FIG. 6 is a view of illustrating a third embodiment of forming a black frame of a plasma display apparatus of the present invention.

FIG. 7 is a view of illustrating a fourth embodiment of forming a black frame of a plasma display apparatus of the present invention.

FIG. 8 is a view for illustrating a region where a black frame of a plasma display apparatus of the present invention may be formed.

### DETAILED DESCRIPTION OF PREFERRED EMBODIMENTS

Preferred embodiments of the present invention will be described in a more detailed manner with reference to the drawings.

A plasma display apparatus according to an embodiment of the present invention comprises a front substrate and a rear substrate; a plurality of barrier ribs of forming a plurality of discharge cells, the barrier ribs formed between the front substrate and the rear substrate; and a black frame separating an effective screen and a non-effective screen of the front substrate, wherein the black frame covers portions of one and more of the outermost discharge cells in the effective screen.

The outermost discharge cells partially located in the effective screen and partially located in the non-effective screen comprise effective discharge cells.

A portion of an inner edge of the black frame aligns with an area where the effective discharge cell adjoins the adjacent dummy discharge cell.

The outermost discharge cells partially located in the effective screen and partially located in the non-effective screen comprise dummy discharge cells.

A portion of an inner edge of the black frame aligns with an area where the effective discharge cell adjoins the adjacent dummy discharge cell.

The plurality of discharge cells arranged in a delta type format.

The shape of each of the discharge cells is hexagonal.

The shape of each of the discharge cells is tetragonal.

The black frame covers portions of one and more of the outermost discharge cells of the effective screen in a area where the outer edges of the effective discharge cell are not aligned with each other.

The black frame is formed on a film type filter.

The black frame is formed inside or outside the plasma display panel.

The black frame is formed on the front substrate.

A plasma display apparatus according to another embodiment of the present invention comprises a front substrate and a rear substrate; a plurality of barrier ribs forming a plurality of discharge cells arranged in a delta type format, the barrier ribs formed between the front substrate and the rear substrate; and a black frame of dividing an effective screen and a non-effective screen of the front substrate, wherein the black frame covers portions of one and more of the outermost discharge cells partially located in the effective screen.

The outermost discharge cells partially located in the effective screen and partially located in the non-effective screen comprise effective discharge cells.

A portion of an inner edge of the black frame aligns with an area where the effective discharge cell adjoins the adjacent dummy discharge cell.

The outermost discharge cells partially located in the effective screen and partially located in the non-effective screen comprise dummy discharge cells.

A portion of an inner edge of the black frame aligns with an area where the effective discharge cell adjoins the adjacent dummy discharge cell.

The shape of each of the discharge cells is hexagonal.

The shape of each of the discharge cells is tetragonal.

An embodiment of the present invention will be described below with reference to the accompanying drawing.

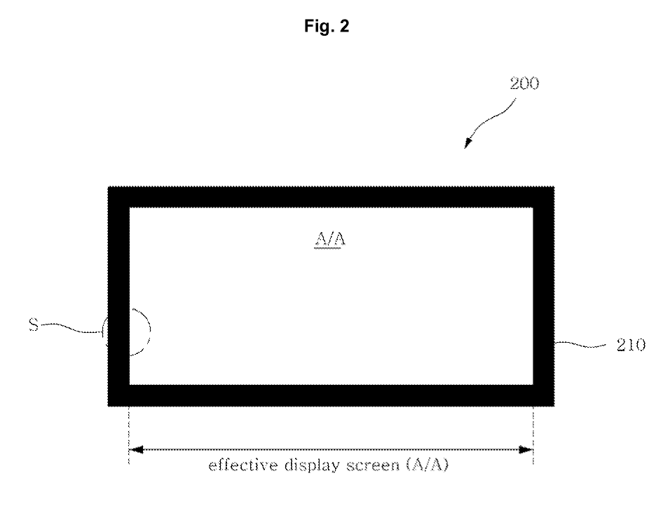

FIG. 2 is a view of illustrating an example of a black frame formed on a plasma display panel of the present invention.

As shown in FIG. 2, the black frame 210 according to an embodiment of the plasma display apparatus of the present invention may define the effective display screen A/A by covering the verge of the plasma display panel 200, i.e. a non-effective screen, and also make better luminous property by covering unnecessary portion of the verge of the plasma display panel and thus improving the object grey level expression displayed on the effective screen.

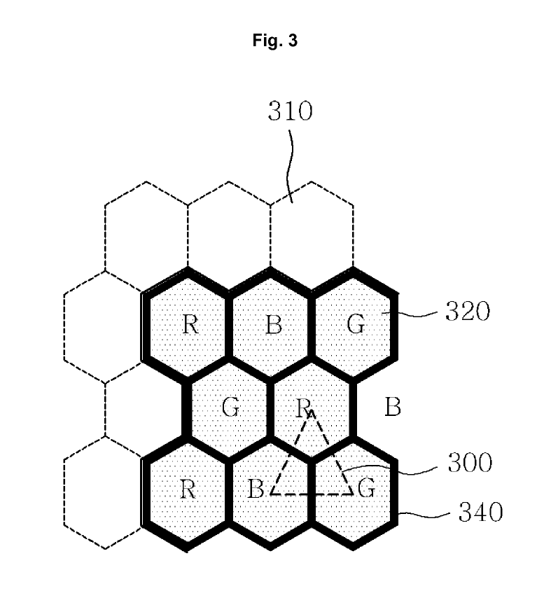

More detailed description on location of the black frame 210 will be described below with reference to FIG. 3, which shows discharge cells formed within the panel in the location corresponding to a border S of the effective display screen A/A and non-effective screen.

FIG. 3 is a view of showing an example of a delta type discharge cell structure for illustrating an example of a plasma display apparatus of the present invention.

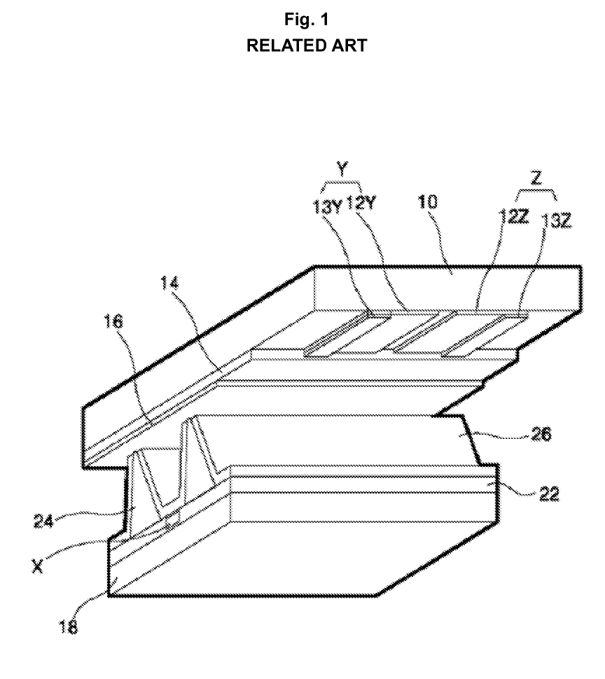

As shown in FIG. 3, the discharge cells are defined by attaching the front substrate 10 and rear substrate 18 of FIG. 1, and the discharge cell, for example, constitutes one pixel which comprises sub discharge cells, each of which is applied with Red, Green, and Blue phosphors.

Here, the discharge cells are arranged to have a delta type structure 300 to raise their density among the Red, Green, Blue sub discharge cells. This delta type 300 of discharge cell structure has advantages compared to the discharge cell structure defined by barrier ribs having a stripe structure as shown in FIG. 1, in that it may improve the brightness from the increase of area to be applied with phosphors, and as well provide delicate pixel expression from the increase of density among the respective sub discharge cells which represent one pixel, thus making it possible to implement high resolution.

FIG. 3 shows a hexagonal discharge cell, an example of the delta type 300. Among the aforementioned discharge cells, the discharge cell 310 located in the verge is not used in display discharge since its driving pulse is unstable and it is ready to cause undesired discharge, which is called dummy discharge cell 310.

The dummy discharge cell 310 affects on its neighboring effective discharge cell 320 of effective discharge cells which are applied with phosphors R, G, B to display images through generating display discharge. Thus, this exerts a bad influence on the object grey level expression displayed by the effective discharge cell 320. Therefore, the black frame 210 may improve the display property of the effective screen displayed by the effective discharge cells 320 by covering the dummy discharge cells 310, thus making better luminous property.

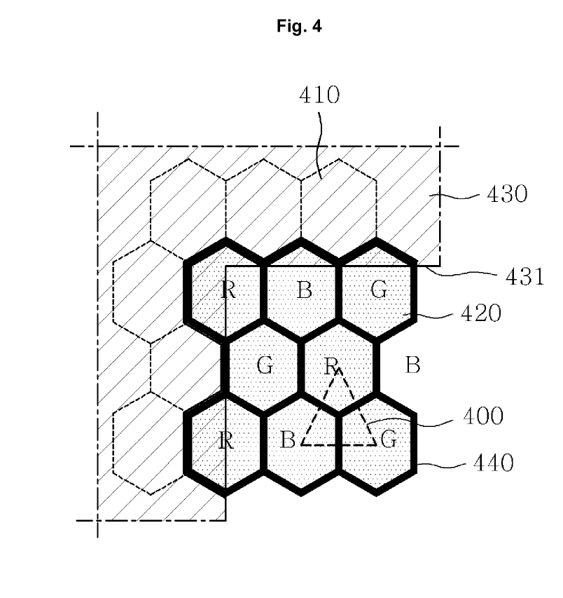

FIG. 4 is a view of illustrating a first embodiment of forming a black frame of a plasma display apparatus of the present invention.

As shown in FIG. 4, barrier ribs 440 define discharge cells 410, 420 to be discharge cells between the front substrate (10 of FIG. 1) and rear substrate (18 of FIG. 1) of the plasma display panel. A black frame 430 according to a first embodiment of the plasma display apparatus of the present invention covers the verge of the panel, i.e. a non-effective screen and divides an effective screen and a non-effective screen to thus define an effective display screen. Here, the inner edge 431 of the black frame 430 covers portions of one and more of the outermost discharge cells 420 in the effective screen.

As an example, the outermost discharge cells may also be the effective discharge cells 420 as in the first embodiment of FIG. 4. That is, the black frame 430 may cover portions of one and more of the outermost discharge cells to be the effective discharge cells 420.

Moreover, a portion of the inner edge 431 of the black frame 430 may be arranged in an area where the effective discharge cell 420 and the dummy discharge cell 410 are adjoining each other.

In addition, by configuring the entire form of the discharge cell in a delta type 400 may raise density among the respective sub discharge cells and thus provide a delicate pixel expression.

In addition, the shape of the discharge cell may be formed to be polygonal, for example, hexagonal as in FIG. 4.

As such, although the inner edge 431 of the black frame is formed to be a straight line as shown in FIG. 4, the effective screen may be efficiently defined, and accuracy of alignment may be improved during the manufacturing process.

It is also possible to form the inner edge 431 of the black frame to correspond to any one of the outermost effective discharge cells 420 in the first embodiment of the present invention shown in FIG. 4. Thus, by covering all the dummy discharge cells 410 may improve the object grey level expression displayed by the effective discharge cells 420 and thus make better luminous property.

More desirably, the inner edge 431 of the black frame is arranged in the area where the effective discharge cell 420 and dummy discharge cell 410 are adjoining each other, so that the dummy discharge cells 420 are all covered while the effective display region by the effective discharge cells 420 are maximized, and this allows for improving the brightness.

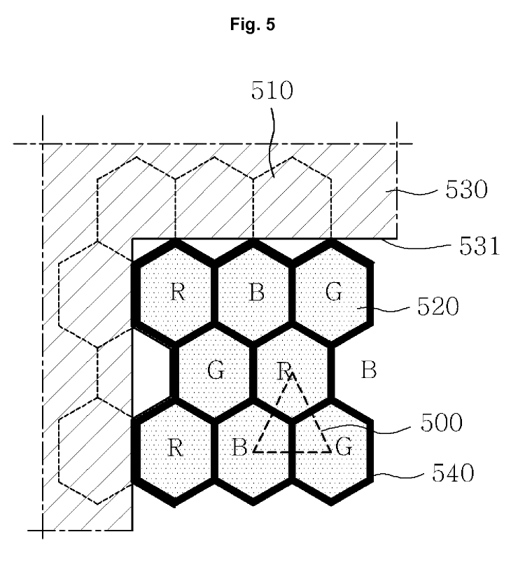

A second embodiment of the plasma display apparatus of the present invention will now be described below with reference to FIG. 5.

FIG. 5 is a view of illustrating a second embodiment of forming a black frame of a plasma display apparatus of the present invention.

As shown in FIG. 5, barrier ribs 540 define discharge cells 510, 520 to be discharge cells between the front substrate (10 of FIG. 1) and rear substrate (18 of FIG. 1) of the plasma display panel. A black frame 530 according to the second embodiment of the plasma display apparatus of the present invention covers the verge of the panel, i.e. a non-effective screen and divides an effective screen and a non-effective screen to thus define an effective display screen. Here, the inner edge 531 of the black frame 530 covers portions of one and more of the outermost discharge cells 510 in the effective screen.

As an example, the outermost discharge cells may also be the effective discharge cells 510 as in the second embodiment of FIG. 5. That is, the black frame 530 may cover portions of one and more of the outermost discharge cells to be the dummy discharge cells 510.

Moreover, a portion of the inner edge 531 of the black frame 530 may be arranged in an area where the effective discharge cell 520 and the dummy discharge cell 510 are adjoining each other.

In addition, by configuring the entire form of the discharge cell in a delta type 500 may raise density among the respective sub discharge cells and thus provide a delicate pixel expression.

In addition, the shape of the discharge cell may be formed to be polygonal, for example, hexagonal as in FIG. 5.

As such, although the inner edge 531 of the black frame is formed to be a straight line as shown in FIG. 5, the effective screen may be efficiently defined, and accuracy of alignment may be improved during the manufacturing process.

In addition, the inner edge 531 of the black frame is arranged in the area where the effective discharge cell 520 and dummy discharge cell 510 are adjoining each other in the second embodiment of the present invention as shown in FIG. 5. That is, by forming the inner edge 531 of the black frame to correspond to the outermost effective discharge cell 510, the effective discharge cells 520 are all seen from the outside, and this allows for maximizing the effective display region displayed by the effective discharge cells 520 and improving the brightness.

Furthermore, this allows for covering the dummy discharge cells 510 as much as possible which have a bad influence on the object grey level expression created by the effective discharge cells 520 and thus improving luminous property.

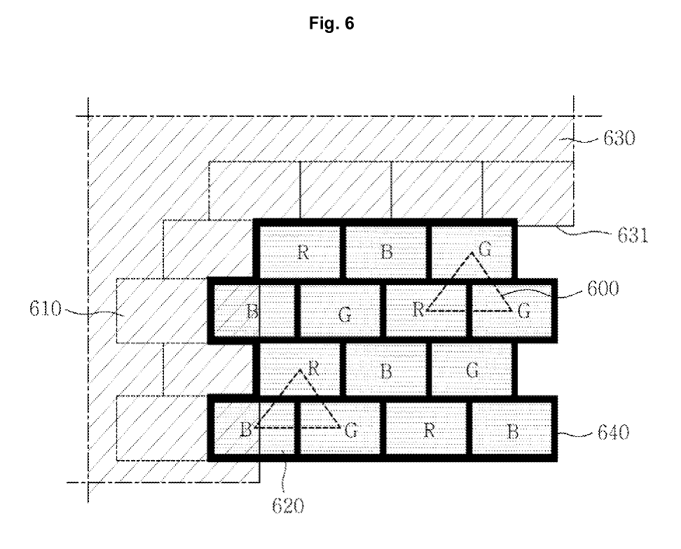

A third embodiment of the plasma display apparatus of the present invention will now be described below with reference to FIG. 6.

FIG. 6 is a view of illustrating a third embodiment of forming a black frame of a plasma display apparatus of the present invention.

As shown in FIG. 6, barrier ribs 640 define discharge cells 610, 620 to be discharge cells between the front substrate (10 of FIG. 1) and rear substrate (18 of FIG. 1) of the plasma display panel. An inner edge 631 of a black frame 630 according to the third embodiment of the plasma display apparatus of the present invention covers the verge of the panel, i.e. a non-effective screen and divides an effective screen and a non-effective screen to thus define an effective display screen. Here, the inner edge 631 of the black frame 630 covers portions of one and more of the outermost discharge cells 620 in the effective screen.

As an example, the outermost discharge cells may also be the effective discharge cells 620 as in the third embodiment of FIG. 6. That is, the black frame 630 may cover portions of one and more of the outermost discharge cells to be the effective discharge cells 620.

Here, the black frame 630 may cover portions of the outermost discharge cells 620 of the effective screen in areas where the border line of the effective discharge cell 620 and dummy discharge cell 610 is a non-straight line, and as an example, the black frame 630 may cover portions of one and more of the outermost discharge cells 620 located in the leftmost end and rightmost end as in FIG. 6.

Moreover, the inner edge 631 of the black frame 63 may be arranged in an area where the effective discharge cell 620 and the dummy discharge cell 610 are adjoining each other.

In addition, by configuring the entire form of the discharge cell in a delta type 600 may raise density among the respective sub discharge cells and thus provide a delicate pixel expression.

In addition, the shape of the discharge cell may be formed to be polygonal, for example, tetragonal as in FIG. 6.

As such, although the inner edge 631 of the black frame is formed to be a straight line as shown in FIG. 6, the effective screen may be efficiently defined, and accuracy of alignment may be improved during the manufacturing process.

It is also possible to form the inner edge 631 of the black frame to correspond to any one of the outermost effective discharge cells 620 in the third embodiment of the present invention shown in FIG. 6. Thus, by covering all the dummy discharge cells 610 may improve the object grey level expression displayed by the effective discharge cells 620 and thus make better luminous property.

More desirably, the inner edge 631 of the black frame is arranged in the area where the effective discharge cell 620 and dummy discharge cell 610 are adjoining each other, so that the dummy discharge cells 610 are all covered while the effective display region by the effective discharge cells 620 are maximized, and this allows for improving the brightness.

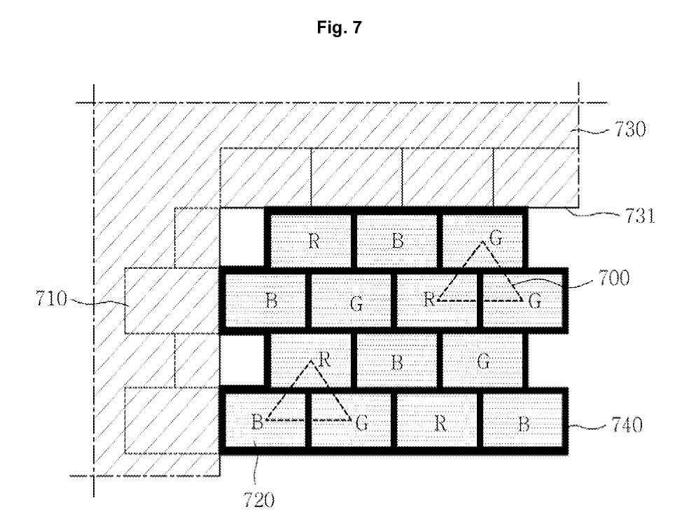

In addition, a fourth embodiment of the plasma display apparatus of the present invention will now be described below with reference to FIG. 7.

FIG. 7 is a view of illustrating a fourth embodiment of forming a black frame of a plasma display apparatus of the present invention.

As shown in FIG. 7, barrier ribs 740 define discharge cells 710, 720 to be discharge cells between the front substrate (10 of FIG. 1) and rear substrate (18 of FIG. 1) of the plasma display panel. An inner edge 731 of a black frame 730 according to the fourth embodiment of the plasma display apparatus of the present invention covers the verge of the panel, i.e. a non-effective screen and divides an effective screen and a non-effective screen to thus define an effective display screen. Here, the inner edge 731 of the black frame 730 covers portions of one and more of the outermost discharge cells 710 in the effective screen.

As an example, the outermost discharge cells may also be the dummy discharge cells 710 as in the fourth embodiment of FIG. 7. That is, the black frame 730 may cover portions of one and more of the outermost discharge cells to be the dummy discharge cells 710.

Here, the black frame 730 may cover portions of the outermost discharge cells 720 of the effective screen in areas where the border line of the effective discharge cell 710 and dummy discharge cell 710 is a non-straight line, and as an example, the black frame 630 may cover portions of one and more of the outermost discharge cells 710 located in the leftmost end and rightmost end as in FIG. 7.

Moreover, the inner edge 731 of the black frame 730 may be arranged in an area where the effective discharge cell 720 and the dummy discharge cell 710 are adjoining each other.

In addition, by configuring the entire form of the discharge cell in a delta type 700 may raise density among the respective sub discharge cells and thus provide a delicate pixel expression.

In addition, the shape of each discharge cell may be formed to be polygonal, for example, tetragonal as in FIG. 7.

As such, although the inner edge 731 of the black frame is formed to be a straight line as shown in FIG. 7, the effective screen may be efficiently defined, and thus accuracy of alignment may be improved during the manufacturing process.

In addition, the inner edge 731 of the black frame is arranged in the area where the effective discharge cell 720 and dummy discharge cell 710 are adjoining each other in the fourth embodiment of the present invention as shown in FIG. 7. That is, by forming the inner edge 731 of the black frame to correspond to the outermost effective discharge cell 710, the effective discharge cells 720 are all seen from the outside, and this allows for maximizing the effective display region displayed by the effective discharge cells 720 and improving the brightness.

Furthermore, this allows for covering the dummy discharge cells 710 as much as possible and improving more delicately the object grey level expression created by the effective discharge cells 720, thus optimizing luminous property.

The above mentioned examples are only embodiments according to the present invention. Therefore, these are not limited to the delta type discharge as illustrated above but also applicable to all structures in which the outline of the discharge cells corresponding to the border of the effective screen and non-effective screens is not a straight line.

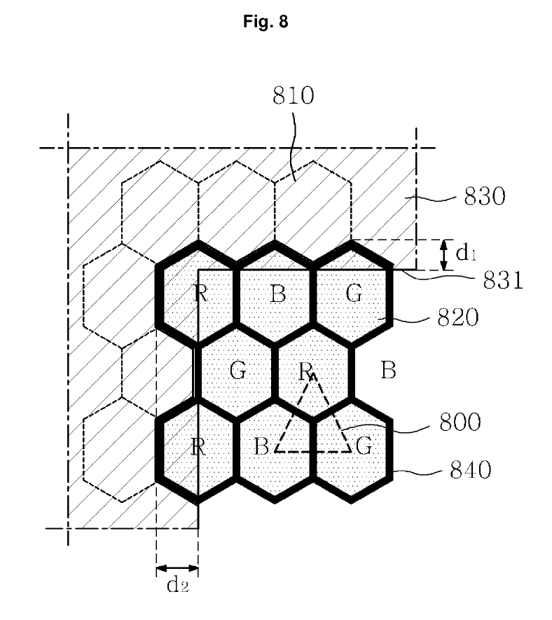

Furthermore, the location where the inner edge of the black frame is formed is not limited to the aforementioned embodiments, but adjustable in various ways to optimize luminous property and brightness, which will now be described with reference to FIG. 8.

FIG. 8 is a view for illustrating a region where a black frame of a plasma display apparatus of the present invention may be formed.

As shown in FIG. 8, a black frame 830 according to the plasma display apparatus of the present invention is adapted to cover portions of one and more of the outermost discharge cells of the effective screen. Here, the location of the inner edge 831 of the black frame 830 is adjustable within the range of d1 of a horizontal direction in FIG. 8. In addition, the location is adjustable within the range of d2 of the vertical direction in FIG. 8.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus comprising:
a front substrate and a rear substrate;
a plurality of barrier ribs forming a plurality of discharge cells, the barrier ribs formed between the front substrate and the rear substrate; and
a black frame separating an effective screen and a non-effective screen of the front substrate, wherein
the black frame covers portions of one and more of the outermost discharge cells in the effective screen.

2. The plasma display apparatus of claim 1, wherein
the outermost discharge cells partially located in the effective screen and partially located in the non-effective screen comprise effective discharge cells.

3. The plasma display apparatus of claim 2, wherein
a portion of an inner edge of the black frame aligns with an area where the effective discharge cell adjoins the adjacent dummy discharge cell.

4. The plasma display apparatus of claim 1, wherein
the outermost discharge cells partially located in the effective screen and partially located in the non-effective screen comprise dummy discharge cells.

5. The plasma display apparatus of claim 4, wherein
a portion of an inner edge of the black frame aligns with an area where the effective discharge cell adjoins the adjacent dummy discharge cell.

6. The plasma display apparatus of claim 1, wherein
the plurality of discharge cells arranged in a delta type format.

7. The plasma display apparatus of claim 6, wherein
the shape of each of the discharge cells is hexagonal.

8. The plasma display apparatus of claim 6, wherein
the shape of each of the discharge cells is tetragonal.

9. The plasma display apparatus of claim 8, wherein
the black frame covers portions of one and more of the outermost discharge cells of the effective screen in a area where the outer edges of the effective discharge cell are not aligned with each other

10. The plasma display apparatus of claim 1, wherein
the black frame is formed on a film type filter.

11. The plasma display apparatus of claim 1, wherein
the black frame is formed inside or outside the plasma display panel.

12. The plasma display apparatus of claim 1, wherein
the black frame is formed on the front substrate.

13. A plasma display apparatus comprising:
a front substrate and a rear substrate;
a plurality of barrier ribs forming a plurality of discharge cells arranged in a delta type format, the barrier ribs formed between the front substrate and the rear substrate; and
a black frame of dividing an effective screen and a non-effective screen of the front substrate, wherein
the black frame covers portions of one and more of the outermost discharge cells partially located in the effective screen.

14. The plasma display apparatus of claim 13, wherein
the outermost discharge cells partially located in the effective screen and partially located in the non-effective screen comprise effective discharge cells.

15. The plasma display apparatus of claim 14, wherein
a portion of an inner edge of the black frame aligns with an area where the effective discharge cell adjoins the adjacent dummy discharge cell.

16. The plasma display apparatus of claim 13, wherein
the outermost discharge cells partially located in the effective screen and partially located in the non-effective screen comprise dummy discharge cells.

17. The plasma display apparatus of claim 16, wherein
a portion of an inner edge of the black frame aligns with an area where the effective discharge cell adjoins the adjacent dummy discharge cell.

18. The plasma display apparatus of claim 13, wherein
the shape of each of the discharge cells is hexagonal.

19. The plasma display apparatus of claim 13, wherein
the shape of each of the discharge cells is tetragonal.
